(19) United States
(12) Patent Application Publication
(10) Pub. No.: US 2023/0028786 A1
(43) Pub. Date: Jan. 26, 2023

(54) CATALYST COMPONENTS FOR THE POLYMERIZATION OF OLEFINS

(71) Applicant: BASELL POLIOLEFINE ITALIA S.R.L., MILANO (IT)

(72) Inventors: SIMONA GUIDOTTI, FERRARA (IT); DARIO LIGUORI, FERRARA (IT); GIAMPIERO MORINI, FERRARA (IT)

(73) Assignee: BASELL POLIOLEFINE ITALIA S.R.L., MILANO (IT)

(21) Appl. No.: 17/781,952

(22) PCT Filed: Nov. 30, 2020
(86) PCT No.: PCT/EP2020/083978

§ 371 Date: Jun. 2, 2022

(30) Foreign Application Priority Data
Dec. 11, 2019 (EP) 19215185.0

(51) Int. Cl. C08F 110/02; C08F 210/16

(52) U.S. Cl. CPC C08F 110/02; C08F 210/16; C08F 2500/08

(57) ABSTRACT

A solid catalyst component for the homopolymerization or copolymerization of olefins, made from or containing Ti, Mg, halogen, and at least one non-aromatic diazo compounds.

### FIELD OF THE INVENTION

In general, the present disclosure relates to the field of chemistry. More specifically, the present disclosure relates to polymer chemistry. In particular, the present disclosure relates to a catalyst component for the polymerization of olefins.

### BACKGROUND OF THE INVENTION

The family of linear low-density polyethylene (LLDPE) includes ethylene/α-olefin copolymers with a density in the range 0.88-0.925 g/cm³. These copolymers are used in many sectors, including the field of wrapping and packaging of goods. LLDPE is commercially produced with liquid phase processes (solution or slurry) and gas-phase processes. Both processes involve the widespread use of Ziegler-Natta MgCl₂-supported catalysts.

In some instances, for the preparation of LLDPE, catalysts are evaluated for comonomer distribution and polymerization yields.

In some instances, high quality ethylene copolymers have (i) the comonomer randomly or alternatively distributed along the polymer chain, (ii) the polymer fractions with a similar average content of comonomer (narrow distribution of composition), and (iii) a low content of polymer fractions soluble in hydrocarbon solvents.

In some instances, single-site homogeneous catalysts provide these properties to ethylene copolymers produced in solution processes. However, these single-site homogeneous catalysts are less effective in terms of activity and polymer morphology in gas-phase polymerization.

### SUMMARY OF THE INVENTION

In a general embodiment, the present disclosure provides a solid catalyst component for the homopolymerization or copolymerization of olefins, made from or containing Mg, Ti, halogen, and at least one compound of formula (I)

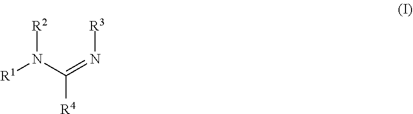

wherein
R¹ is selected from the group consisting of hydrogen and C₁-C₁₅ linear, branched or cyclic hydrocarbon groups;
R² is selected from the group consisting of hydrogen and C₁-C₁₅ linear, branched or cyclic hydrocarbon groups;
R³ is selected from the group consisting of hydrogen and C₁-C₁₅ linear, branched or cyclic hydrocarbon groups; and
R⁴ is selected from the group consisting of hydrogen, C₁-C₁₅ hydrocarbon groups, and —NR⁵R⁶, wherein
R⁵ is selected from the group consisting of hydrogen and C₁-C₁₅ linear, branched or cyclic hydrocarbon groups and
R⁶ is selected from the group consisting of hydrogen and C₁-C₁₅ linear, branched or cyclic hydrocarbon groups,
wherein compound (I) being present in an amount such that the compound (I)/Ti molar ratio in the final solid catalyst component ranges from 0.2 to 6. In some embodiments, the two couples of groups, R¹ with R⁴ and R² with R³, are joined to form a non-aromatic cyclic structure.

### DETAILED DESCRIPTION OF THE INVENTION

In some embodiments, and in the compound of formula (I), R¹ and R² are selected from C₁-C₁₀, alternatively C₁-C₅, alkyl groups; R³ is selected from hydrogen or C₁-C₅ alkyl groups; and R⁴ is selected from —NR⁵R⁶ groups, wherein R⁵ and R⁶ are selected from hydrogen or C₁-C₅ alkyl groups. In some embodiment, the compound of formula (I) is selected from the group consisting of 1,1-dipropylguanidine, 1-ethyl-1-propylguanidine, 1-methyl-1-propylguanidine, 1-butyl-1-propylguanidine, 1-ethyl-1-methylguanidine, 1,1-dimethylguanidine, 1-butyl-1-methylguanidine, 1,1-diethylguanidine, 1-butyl-1-ethylguanidine, 1,1-dibutylguanidine, 1-butyl-3,3-dimethyl-1-propylguanidine, 1-butyl-1-ethyl-3,3-dimethylguanidine, 1-butyl-1,3,3-trimethylguanidine, 1,1-dibutyl-3,3-dimethylguanidine, 1-butyl-3,3-diethyl-1-propylguanidine, 1-butyl-1,3,3-triethylguanidine, 1-butyl-3,3-diethyl-1-methylguanidine, 1,1-dibutyl-3,3-diethylguanidine, 1-ethyl-3,3-dimethyl-1-propylguanidine, 1,1,3-triethyl-3-propylguanidine, 1,1-diethyl-3,3-dimethylguanidine, 1-ethyl-1,3,3-trimethylguanidine, 1,1,3,3-tetraethylguanidine, 1,1,3,3-tetramethylguanidine, 1,1,3-triethyl-3-methylguanidine, 1,1,3-trimethyl-3-propylguanidine, 1,1-diethyl-3-methyl-3-propylguanidine, 1,1-diethyl-3,3-dimethylguanidine, 1,1-dimethyl-3,3-dipropylguanidine, and 1,1-diethyl-3,3-dipropylguanidine]. In some embodiment, the compound of formula (I) is 1,1,3,3-tetramethyl guanidine (TMG).

In some embodiments, in the compound of formula (I), the couples of R¹-R⁴ and R²-R³ are joined together to form non-aromatic ring structures. In some embodiments, the couples of R¹-R⁴ and R²-R³ are joined to form ring structures. In some embodiments, the rings are made of five or more members. In some embodiments, the couple R¹-R⁴ forms a 5-7 members saturated ring structure, and the couple R²-R³ forms a six-member unsaturated ring, having the C═N double bond. In view of the backbone of the compound of formula (I), when the couples of R¹-R⁴ and R²-R³ are joined together to form non-aromatic cyclic structures, compounds having fused heterocyclic rings are obtained. In some embodiments, the compounds of formula (I) are selected from the group consisting of 2,5,6,7-tetrahydro-3H-pyrrolo[1,2-α]imidazole, 2,3,5,6,7,8-hexahydroimidazo[1,2-α]pyridine, 2,5,6,7,8,9-hexahydro-3H-imidazo[1,2-α]azepine, 2,3,4,6,7,8,9,10-octahydropyrimido[1,2-α]azepine, 1,8-diazabicyclo[5.4.0]undec-7-ene, 3,4,6,7,8,9-hexahydro-2H-pyrido[1,2-α]pyrimidine, 1,5-diazabicyclo[4.3.0]non-5-ene], and 2,3,4,6,7,8-hexahydropyrrolo[1,2-α]pyrimidine. In some embodiments, the compounds of formula (I) are selected from the group consisting of 1,8-diazabicyclo[5.4.0]undec-7-ene (DBU) and 1,5-diazabicyclo[4.3.0] non-5-ene (DBN).

In some embodiments, the solid catalyst components are made from or containing a compound of formula (I) and a titanium compound having at least a Ti-halogen bond supported on a Mg halide. In some embodiments, the magnesium halide is MgCl₂.

In some embodiments, the titanium compounds are selected from the group consisting of TiCl₄ and TiCl₃. In some embodiments, the titanium compounds are selected from the group consisting of Ti-haloalcoholates of formula Ti(OR⁷)_{m-y}X_{y}, wherein m is the valence of titanium, y is a number between 1 and m−1, X is halogen, and R⁷ is a hydrocarbon radical having from 1 to 10 carbon atoms.

In some embodiments, the solid catalyst component is prepared by reacting a titanium compound with a magnesium chloride deriving from an adduct of formula MgCl₂.pR⁸OH, where p is a number between 0.1 and 6, alternatively from 2 to 3.5, and R⁸ is a hydrocarbon radical having 1-18 carbon atoms. In some embodiments, the titanium compound is TiCl₄. In some embodiments, the adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts are as described in U.S. Pat. Nos. 4,399,054 and 4,469,648. In some embodiments, the adduct is directly reacted with Ti compound or subjected to thermal controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄. In some embodiments, cold TiCl₄ is at about 0° C. In some embodiments, the mixture is heated up to 80-130° C. and maintained at this temperature for 0.5-2 hours. In some embodiments, the treatment with TiCl₄ is carried out one or more times. In some embodiments, the compound (I) is added during the treatment with TiCl₄.

In some embodiments, the solid catalyst component is prepared by

(a) contacting a MgCl₂.pR⁸OH adduct with a liquid medium made from or containing a Ti compound having at least a Ti—Cl bond, in an amount such that the Ti/Mg molar ratio is greater than 3, thereby forming a solid intermediate; and
(b) contacting the compound (I) with the solid intermediate product coming from (a) followed by washing the resulting product.

In some embodiments, the contact is carried out in a liquid medium such as a liquid hydrocarbon. In some embodiments, the temperature at which the contact takes place varies depending on the nature of the reagents, alternatively from −10° to 150° C., alternatively from 0° to 120° C. It is believed that temperatures that can decompose or degrade the reagents are to be avoided. In some embodiments, the time of the treatment varies depending on the nature of the reagents, temperature, and concentration. In some embodiments, this contact step lasts from 10 minutes to 10 hours, alternatively from 0.5 to 5 hours. In some embodiments, and to increase the final donor content, this step is repeated one or more times.

In some embodiments, and at the end of this step, the solid is recovered by separation of the suspension. In some embodiments, the separation method is selected from the group consisting of settling and removing of the liquid, filtration, and centrifugation. In some embodiments, the solid is subjected to washings with solvents. In some embodiments, the washings are carried out with inert hydrocarbon liquids or with polar solvents. In some embodiments, the polar solvents have a higher dielectric constant. In some embodiments, the polar solvents are halogenated or oxygenated hydrocarbons.

In some embodiments, the process further includes the step of subjecting the solid coming from step (a) to a prepolymerization step (a2) before carrying out step (b).

In some embodiments, the pre-polymerization is carried out with an olefin CH₂═CHR, wherein R is H or a C₁-C₁₀ hydrocarbon group. In some embodiments, ethylene or propylene or mixtures thereof are pre-polymerized with one or more α-olefins. In some embodiments, the mixtures contain up to 20% in moles of α-olefin and form amounts of polymer from about 0.1 g up to about 1000 g per gram of solid intermediate, alternatively from about 0.5 to about 500 g per gram of solid intermediate, alternatively from 0.5 to 50 g per gram of solid intermediate, alternatively from 0.5 to 5 g per gram of solid intermediate. In some embodiments, the pre-polymerization step is carried out at temperatures from 0 to 80° C., alternatively from 5 to 70° C., in the liquid or gas phase. In some embodiments, the pre-polymerization of the intermediate with ethylene or propylene produces an amount of polymer ranging from 0.5 to 20 g per gram of intermediate. In some embodiments, the pre-polymerization is carried out with a cocatalyst. In some embodiments, the cocatalyst is selected from organoaluminum compounds. In some embodiments, the solid intermediate is prepolymerized with propylene, and the prepolymerization is carried out in the presence of one or more external donors. In some embodiments, the external donors are selected from the group consisting of silicon compounds of formula Rₐ⁹R_{b}¹⁰Si(OR¹¹)_{c}, wherein a and b are integer from 0 to 2, c is an integer from 1 to 3 and the sum (a+b+c) is 4; R⁹, R¹⁰, and R¹¹, are alkyl, cycloalkyl or aryl radicals with 1-18 carbon atoms optionally containing heteroatoms. In some embodiments, the silicon compounds are wherein a is 1, b is 1, c is 2, at least one of R⁹ and R¹⁰ is selected from branched alkyl, cycloalkyl or aryl groups with 3-10 carbon atoms optionally containing heteroatoms and R¹¹ is a C₁-C₁₀ alkyl group. In some embodiments, R¹¹ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), and diisopropyldimethoxysilane,

As used herein, the term “substantially spherical morphology” refers to particles having the ratio between the greater axis and the smaller axis equal to, or lower than 1.5, alternatively lower than 1.3. In some embodiments, the particles of solid catalyst components have substantially spherical morphology and an average diameter between 5 and 150 μm, alternatively from 10 to 100 μm.

In some embodiments, the compound (I)/Ti molar ratio in the final solid catalyst component ranges from 0.2 to 6, alternatively from 0.3 to higher than 1.5, alternatively from 0.3 to 5, alternatively from 0.4 to 4.

In some embodiments, the content of compound (I) ranges from 1 to 30% wt with respect to the total weight of the solid catalyst component (not prepolymerized), alternatively from 2 to 20% wt.

In some embodiments, the Mg/Ti molar ratio ranges from 5 to 50, alternatively from 10 to 40.

In some embodiments, the solid catalyst components have a surface area (by B.E.T. method) between 10 and 200 m²/g, alternatively between 20 and 80 m²/g, and a total porosity (by B.E.T. method) higher than 0.15 cm³/g, alternatively between 0.2 and 0.6 cm³/g. In some embodiments, the porosity (Hg method) due to pores with radius up to 10.000 Å ranges from 0.25 to 1 cm³/g, alternatively from 0.35 to 0.8 cm³/g.

In some embodiments, the catalyst components are used to form catalysts, for the polymerization of alpha-olefins CH₂═CHR, wherein R is hydrogen or a hydrocarbon radical having 1-12 carbon atoms, by reaction with Al-alkyl compounds. In some embodiments, a catalyst system for the polymerization of olefins is made from or containing the product of the reaction between (A) a solid catalyst component, (B) an alkylaluminum compound and, optionally, and (C) an external electron donor compound (ED). In some embodiments, the alkylaluminum compound are Al-trialkyl compounds. In some embodiments, the Al-trialkyl compounds are selected from the group consisting of Al-trimethyl, Al-triethyl, Al-tri-n-butyl, and Al-triisobutyl. In some embodiments, the Al/Ti ratio is higher than 1, alternatively between 5 and 800.

In some embodiments, the Al-alkyl compounds are selected from the group consisting of alkylaluminum halides. In some embodiments, the alkylaluminum halides are alkylaluminum chlorides. In some embodiments, the alkylaluminum chlorides are selected from the group consisting of diethylaluminum chloride (DEAC), diisobutylaluminum chloride, Al-sesquichloride, and dimethylaluminum chloride (DMAC). In some embodiments, the Al-alkyl compounds are mixtures of trialkylaluminum compounds with alkylaluminum halides. In some embodiments, the mixtures are selected from the group consisting of TEAL/DEAC and TIBA/DEAC.

In some embodiments, an external electron donor (ED) is used during polymerization. In some embodiments, the external electron donor compound is the same as, or different from, the internal donors used in the solid catalyst component. In some embodiments, the external electron donor compound is selected from the group consisting of ethers, esters, amines, ketones, nitriles, silanes, and mixtures of the above. In some embodiments, the external electron donor compound is selected from the C₂-C₂₀ aliphatic ethers, alternatively cyclic ethers, alternatively 3-5 carbon atoms cyclic ethers. In some embodiments, the 3-5 carbon atoms cyclic ethers is selected from the group consisting of tetrahydrofuran and dioxane.

In some embodiments, a halogenated compound (D), as activity enhancer, is used during polymerization. In some embodiments, the halogenated compound (D) is a monohalogenated or dihalogenated hydrocarbon. In some embodiments, the halogenated compound (D) is selected from the group consisting of monohalogenated hydrocarbons, wherein the halogen is linked to a secondary carbon atom. In some embodiments, the halogen is selected from the group consisting of chloride and bromide.

In some embodiments, the halogenated compound (D) is selected from the group consisting of propylchloride, i-propylchloride, butylchloride, s-butylchloride, t-butylchloride 2-chlorobutane, cyclopentylchloride, cyclohexylchloride, 1,2-dichloroethane, 1,6-dichlorohexane, propylbromide, i-propylbromide, butylbromide, s-butylbromide, t-butylbromide, i-butylbromide i-pentylbromide, and t-pentylbromide. In some embodiments, the halogenated compound (D) is selected from the group consisting of i-propylchloride, 2-chlorobutane, cyclopentylchloride, cyclohexylchloride, 1,4-dichlorobutane, and 2-bromopropane.

In some embodiments, the halogenated compound (D) is selected from the group consisting of halogenated alcohols, halogenated esters, and halogenated ethers. In some embodiments, the halogenated compound (D) is selected from the group consisting of 2,2,2-trichloroethanol, ethyl trichloroacetate, butyl perchlorocrotonate, 2-chloro propionate, and 2-chloro-tetrahydrofuran.

In some embodiments, the activity enhancer is used in amounts to have the (B)/(D) molar ratio of higher than 3, alternatively in the range 5-50, alternatively in the range 10-40.

In some embodiments, the present disclosure provides a process for the homopolymerization or copolymerization of olefins CH₂═CHR, wherein R is hydrogen or a hydrocarbyl radical with 1-12 carbon atoms, carried out in the presence of the catalyst.

In some embodiments, the polymerization process is carried out in slurry polymerization using as diluent an inert hydrocarbon solvent, or bulk polymerization using the liquid monomer as a reaction medium. In some embodiments, the liquid monomer is propylene. In some embodiments, the polymerization process is carried out in gas-phase operating in one or more fluidized or mechanically agitated bed reactors.

In some embodiments, the polymerization is carried out at temperature of from 20 to 120° C., alternatively from 40 to 80° C. In some embodiments, the polymerization is carried out in gas-phase, and the operating pressure ranges between 0.5 and 5 MPa, alternatively between 1 and 4 MPa. In some embodiments, the polymerization is carried out in bulk polymerization, and the operating pressure ranges between 1 and 8 MPa, alternatively between 1.5 and 5 MPa.

In some embodiments, a pre-polymerization step is carried out before the polymerization stage. In some embodiments, and for large scale plants, the conversion in prepolymerization is in the range from 250 g up to about 1000 g per gram of solid catalyst component.

In some embodiments, LLDPE is produced from the copolymerization of ethylene with C₃-C₁₀ α-olefins. In some embodiments, the C₃-C₁₀ α-olefins are selected from the group consisting of propylene, 1-butene, 1-hexene, and 1-octene, and mixtures thereof. In some embodiments, the α-olefin is 1-butene, 1-hexene, or a mixture thereof. In some embodiments, the amount of α-olefin used depends on the density of LLDPE desired. In some embodiments, the α-olefin is used in amount within the range of 5 to 10 wt % of ethylene. In some embodiments, the density of LLDPE is within the range of 0.88 to 0.940 g/cm³, alternatively 0.910 to 0.940 g/cm³, alternatively 0.915 to 0.935 g/cm³. In some embodiments, the LLDPE has a melt index MI″E″ within the range of 0.1 to 10 dg/min, alternatively 0.5 to 8 dg/min.

In some embodiments, the LLDPE resin is a copolymer of ethylene and 1-butene having 1-butene content within the range of 5 to 10 wt %. In some embodiments, the ethylene-1-butene copolymer has a density from 0.912 to 0.925 g/cm³, alternatively 0.915 to 0.920 g/cm³. In some embodiments, the ethylene-1-butene copolymer has an MI″E″ within the range of 0.5 to 15 dg/min, alternatively from 1 to 10 dg/min

In some embodiments, the catalyst components are used for production in gas-phase of LLDPE.

The following examples are given to further describe the present disclosure.

Characterization

The properties are determined according to the following methods:

Determination of Mg, Ti

The determination of Mg, Ti_{(TOT)}, content in the solid catalyst component was carried out via inductively coupled plasma emission spectroscopy on “I.C.P Spectrometer ARL Accuris”.
The sample was prepared by analytically weighing, in a “Fluxy” platinum crucible”, 0.1÷0.3 grams of catalyst and 2 grams of lithium metaborate/tetraborate 1/1 mixture. After addition of some drops of KI solution, the content of the crucible was subjected to complete burning. The residue was collected with a 5% v/v HNO3 solution and then analyzed via ICP at the following wavelengths: magnesium, 279.08 nm; titanium, 368.52 nm;

Determination of Internal Donor Content

The content of internal donor in the solid catalyst component was determined by ¹H NMR analysis. The solid catalyst component (about 40 mg) was dissolved in acetone d⁶ (about 0.6 ml) in the presence of an internal standard and transferred to a 5 mm (O.D.) NMR tube. The amount of donor present was referred to the weight of the catalyst compound.

Determination of Melt Index (MI E, MIF, MIP)

The melt indices were measured at 190° C. according to ASTM D-1238, condition “E” (load of 2.16 kg), “P” (load of 5.0 kg) and “F” (load of 21.6 kg).
The ratio between MIF and MIE is indicated as F/E, while the ratio between MIF and MIP is indicated as F/P.

Determination of Fraction Soluble in Xylene

The solubility in xylene at 25° C. was determined by placing about 2.5 g of polymer and 250 mL of o-xylene in a round-bottomed flask provided with cooler and a reflux condenser and maintained under nitrogen. The mixture was heated to 135° C. and maintained under stirring for about 60 minutes. The final solution was allowed to cool to 25° C. under continuous stirring and then filtered. The filtrate was then evaporated in a nitrogen flow at 140° C. to reach a constant weight. The content of the xylene-soluble fraction is expressed as a percentage of the original 2.5 grams.

Determination of Comonomer Content

1-Butene was determined via ¹³C NMR analysis.
13C NMR spectra were acquired on a Bruker AV-600 spectrometer equipped with cryo-probe, operating at 150.91 MHz in the Fourier transform mode at 120° C.
The peak of the Sδδ carbon (nomenclature according to C. J. Carman, R. A. Harrington and C. E. Wilkes, Macromolecules, 10, 3, 536 (1977)) was used as internal reference at 29.90 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD to remove 1H-13C coupling. About 512 transients were stored in 32K data points using a spectral window of 9000 Hz.
Assignments of the spectra were made according to J. C. Randal, Macromol. Chem Phys., C29, 201 (1989).
Triad distribution and composition were made starting from relations between peaks and triads described by Kakugo et al. modified to consider overlaps of signals in the spectra.

### Triads

### BBB=100 Tββ/S

### BBE=100 Tβδ/S

### EBE=100 2B2 (EBE)/S

### BEB=100 Sββ/S

### BEE=100 Sαδ/S

### EEE=100 (0.25 Sγδ+0.5 Sδδ)/S

### Molar Composition

### B=BBB+BBE+EBE

### E=EEE+BEE+BEB

Determination of Effective Density

Effective density: ASTM-D 1505-10 but referred to MI″E″ 1 g/10′ as corrected by the following equation: density (MIE=1)=density(measured)−0.0024 ln(MI E)

General Procedure for the Preparation of Spherical MgCl₂.(EtOH)m Adducts.

An initial amount of microspheroidal MgCl₂.2.8C₂H₅OH was prepared according to the method described in Example 2 of Patent Cooperation Treaty Publication No. WO98/44009 but on a larger scale. The stirring conditions during the preparation were adjusted to obtain the desired average particle size. The resulting microspheroidal MgCl₂-EtOH adduct was subjected to a thermal treatment under nitrogen stream over a temperature range of 50-150° C., thereby reducing the alcohol content. A solid support material containing 28.5% wt of EtOH, having an average particle size of 23 μm, was obtained.

General Procedure for the LLDPE Polymerization Test in Slurry

A 4.5-liter stainless-steel autoclave equipped with a magnetic stirrer, temperature, pressure indicator, and feeding line for ethylene, propane, 1-butene, and hydrogen, and a steel vial for the injection of the catalyst, was purified by fluxing pure nitrogen at 70° C. for 60 minutes. The autoclave was then washed with propane, heated to 75° C. and finally loaded with 800 grams of propane, 1-butene in the amount reported in Table 1, ethylene (7.0 bar, partial pressure), and hydrogen (1.5 bar, partial pressure). In a separate 100 cm3 round bottom glass flask were 50 cm³ of anhydrous hexane, a cocatalyst mixture solution made from or containing triethyl aluminum/diethyl aluminum chloride (that is, TEA/DEAC 2/1 weight ratio (8.5 mmol of aluminum)), 0.12 g of tetrahydrofuran as external donor, and 0.010÷0.020 grams of the solid catalyst component were subsequently introduced. The contents of the round bottom flask were mixed and stirred at room temperature for 10 minutes and then introduced to the reactor through the steel vial by using nitrogen overpressure. Under continuous stirring, the total pressure was maintained constant at 75° C., thereby absorbing 150 g of ethylene, for a maximum time of 2 h by continuous ethylene feeding into the system. At the end of the polymerization, the reactor was depressurized. The temperature was reduced to 30° C. The recovered polymer was dried at 70° C. under a nitrogen flow and weighed.

### EXAMPLES

### Comparative Example 1

### Preparation of the Solid Component.

Into a 750 mL four-necked round flask, purged with nitrogen, 430 mL of TiCl₄ were introduced at 0° C. Then, at the same temperature, 34.4 grams of the microspheroidal adduct were added under stirring. The temperature was raised to 130° C. and maintained for 1 hour. Then, the stirring was discontinued. The solid product was allowed to settle, and the supernatant liquid was siphoned off. A new amount of fresh TiCl₄ was added to the flask, thereby reaching the initial liquid volume. The temperature was maintained at 110° C. for 0.5 hour. Again, the solid was allowed to settle, and the liquid was siphoned off. The solid was then washed three times with anhydrous heptane (250 mL at each washing) at 90° C. and twice (2×250 mL) at 40° C. with anhydrous hexane. Subsequently, the solid was recovered, dried under vacuum, and analyzed. The solid showed the following characteristics: Ti=4.8% (by weight), Mg=19.1% (by weight). The catalyst performances in slurry copolymerization of ethylene and butene are shown in Table 1.

### Example 2

### Preparation of the Solid Component.

Into a 500 mL four-necked round flask, purged with nitrogen, 195 mL of anhydrous heptane were introduced at room temperature. Then, at the same temperature, 7.7 grams of the solid component described in Example 1 were added under stirring. Subsequently, 0.6 mL of 1.8-diazabicyclo[5.4.0]undec-7-ene (DBU) (Mg/ID molar ratio of 15) were added at room temperature under stirring to the slurry of the solid component in heptane. The temperature was raised to 50° C. and maintained for 1 hour. Then, the stirring was discontinued. The solid product was allowed to settle, and the supernatant liquid was siphoned off. A new amount of fresh anhydrous heptane was added to the flask, thereby reaching the initial liquid volume. The temperature was maintained at 95° C. for 2 hours. Again, the solid was allowed to settle, and the liquid was siphoned off. The solid was then washed two times with anhydrous heptane at 60° C. and twice with anhydrous hexane, at 40° C. and at room temperature. Subsequently, the solid was recovered, dried under vacuum, and analyzed. The solid showed the following characteristics: Ti=3.8% (by weight), Mg=18.6% (by weight), DBU=7.5% (by weight). The catalyst performances in slurry copolymerization of ethylene and butene are shown in Table 1.

### Example 3

### Preparation of the Solid Component.

Into a 500 mL four-necked round flask, purged with nitrogen, 275 mL of TiCl₄ were introduced at 0° C. Then, at the same temperature, 11 grams of the microspheroidal adduct were added under stirring. The temperature was raised to 130° C. and maintained for 1 hour. Then, the stirring was discontinued. The solid product was allowed to settle, and the supernatant liquid was siphoned off. A new amount of fresh TiCl₄ was added to the flask, thereby reaching the initial liquid volume. At ca. 70° C. and under stirring, 1.3 mL of 1,1,3,3-tetramethyl guanidine (TMG), (Mg/ID molar ratio of 8) were slowly added. The temperature was subsequently increased at 115° C. and maintained for 1 hour. Again, the solid was allowed to settle, and the liquid was siphoned off. The solid was then washed three times with anhydrous heptane at 90° C. and twice with anhydrous hexane, at 40° C. and at room temperature. Subsequently, the solid was recovered, dried under vacuum, and analyzed. The solid showed the following characteristics: Ti=5.3% (by weight), Mg=16.5% (by weight), TMG=7.4% (by weight). The catalyst performances in slurry copolymerization of ethylene and butene are shown in Table 1.

TABLE 1

| | | 1-butene | | | | | | | |
|---|---|---|---|---|---|---|---|---|---|
| | ID | fed | Activity | MIE | C₄⁻ | XS | Density | | |
| EX | type | g | Kg/g/h | g/10′ | % wt. | % | g/cm³ | F/P | F/E |
| C1 | none | 100 | 34.7 | 0.72 | 7.6 | 9.6 | 0.921 | 9.5 | 27.4 |
| 2 | DBU | 160 | 5.6 | 0.48 | 7.0 | 5.9 | 0.921 | 9.4 | 24.9 |
| 3 | TMG | 160 | 14.9 | 0.51 | 7.6 | 8.5 | 0.919 | 8.9 | 25.9 |

What is claimed is:

1. A solid catalyst component for the homopolymerization or copolymerization of olefins, comprising Ti, Mg, halogen, and at least one compound of formula (I) 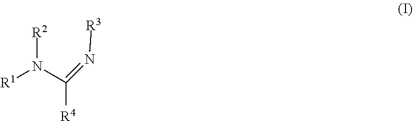
wherein
R¹ is selected from the group consisting of hydrogen and C₁-C₁₅ linear, branched or cyclic hydrocarbon groups;
R² is selected from the group consisting of hydrogen and C1-C15 linear, branched or cyclic hydrocarbon groups;
R3 is selected from the group consisting of hydrogen and C1-C15 linear, branched or cyclic hydrocarbon groups; and
R4 is selected from the group consisting of hydrogen, C1-C15 hydrocarbon groups, and —NR5R6, wherein
R5 is selected from the group consisting of hydrogen and C1-C15 linear, branched or cyclic hydrocarbon groups and
R6 is selected from the group consisting of hydrogen and C1-C15 linear, branched or cyclic hydrocarbon groups;
wherein compound (I) being present in an amount such that the compound (I)/Ti molar ratio in the final solid catalyst component ranges from 0.2 to 6.

2. The solid catalyst component according to claim 1, wherein, in the compound of formula (I), R¹ and R² are selected from C₁-C₁₀ alkyl groups; R³ is selected from hydrogen or C₁-C₅ alkyl groups; and R⁴ is selected from —NR⁵R⁶ groups, wherein R⁵ and R⁶ are selected from hydrogen or C₁-C₅ alkyl groups.

3. The solid catalyst component according to claim 1, wherein the compound of formula (I) is selected from the group consisting of 1,1-dipropylguanidine, 1-ethyl-1-propylguanidine, 1-methyl-1-propylguanidine, 1-butyl-1-propylguanidine, 1-ethyl-1-methylguanidine, 1,1-dimethylguanidine, 1-butyl-1-methylguanidine, 1,1-diethylguanidine, 1-butyl-1-ethylguanidine, 1,1-dibutylguanidine, 1-butyl-3,3-dimethyl-1-propylguanidine, 1-butyl-1-ethyl-3,3-dimethylguanidine, 1-butyl-1,3,3-trimethylguanidine, 1,1-dibutyl-3,3-dimethylguanidine, 1-butyl-3,3-diethyl-1-propylguanidine, 1-butyl-1,3,3-triethylguanidine, 1-butyl-3,3-diethyl-1-methylguanidine, 1,1-dibutyl-3,3-diethylguanidine, 1-ethyl-3,3-dimethyl-1-propylguanidine, 1,1,3-triethyl-3-propylguanidine, 1,1-diethyl-3,3-dimethylguanidine, 1-ethyl-1,3,3-trimethylguanidine, 1,1,3,3-tetraethylguanidine, 1,1,3,3-tetramethylguanidine, 1,1,3-triethyl-3-methylguanidine, 1,1,3-trimethyl-3-propylguanidine, 1,1-diethyl-3-methyl-3-propylguanidine, 1,1-diethyl-3,3-dimethylguanidine, 1,1-dimethyl-3,3-dipropylguanidine, 1,1-diethyl-3,3-dipropylguanidine, and mixtures thereof.

4. The solid catalyst component according to claim 1, wherein the compound of formula (I) is 1,1,3,3-tetramethyl guanidine.

5. The solid catalyst component according to claim 1, wherein, in the compound of formula (I), the couples of R1-R4 and R2-R3 are joined together to form non-aromatic ring structures.

6. The solid catalyst component according to claim 5, wherein, in the compound of formula (I), the couples of R1-R4 and R2-R3 are joined to form ring structures of five or more members.

7. The solid catalyst component according to claim 5, wherein, in the compound of formula (I), the couple R1-R4 forms a 5-7 members saturated ring structure and the couple R2-R3 forms a six-member unsaturated ring.

8. The solid catalyst component according to claim 1, wherein the compound of formula (I) is selected from 1.8-diazabicyclo[5.4.0]undec-7-ene (DBU) and 1,5-diazabicyclo[4.3.0] non-5-ene (DBN).

9. The solid catalyst component according to claim 1, wherein the content of compound (I) ranges from 1 to 30% wt with respect to the total weight of the solid catalyst component.

10. The solid catalyst component according to claim 1, wherein the Mg/Ti molar ratio ranges from 5.0 to 50.

11. A catalyst system for the polymerization of olefins comprising the product of the reaction between:
(A) a solid catalyst component according to claim 1,
(B) an alkylaluminum compound and, optionally,
(C) an external electron donor compound (ED).

12. A process for the homopolymerization or copolymerization of olefins carried out in the presence of a catalyst system according to claim 11.

13. The process according to claim 12 for the preparation of linear low-density polyethylene (LLDPE).

14. The process according to claim 13 being carried out in gas-phase.
